(19) United States
(12) Patent Application Publication
(10) Pub. No.: US 2007/0004356 A1
(43) Pub. Date: Jan. 4, 2007

(54) Noise suppression in an fm receiver

(75) Inventors: Franciscus Josephus Alfonsus Maria Sessink, Nuenen (NL); Henricus Johannes Maria Van Den Heuvel, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/538,368

(22) PCT Filed: Nov. 17, 2003
(86) PCT No.: PCT/IB03/05215

§ 371 Date: Jun. 13, 2005

(30) Foreign Application Priority Data
Dec. 16, 2002 (EP) 02080310.2

(51) Int. Cl. H04B 1/10

(52) U.S. Cl. 455/222

(57) ABSTRACT

A filter circuit for suppressing high frequency noise in an FM-receiver has a first filter branch and a second filter branch connected in parallel. The first filter branch has a high pass filter (11) and a multiplier (13) for multiplying a signal passing through the first filter branch and a control signal indicative of high frequency noise. The second filter branch has a low pass filter

The present invention relates to noise suppression in an FM receiver. More in particular, the present invention relates to a filter circuit for an FM receiver, an FM receiver provided with a filter circuit and a method of suppressing noise in an FM receiver.

It is well known that FM (Frequency Modulation) radio receivers are susceptible to noise. Several types of noise can be identified, such as interference noise caused by other devices producing radiation in the same frequency band, and multipath noise caused by the FM signal reaching the receiver via two or more paths having different lengths. Especially the latter type of noise proves hard to eliminate or even suppress.

U.S. Pat. No. 4,379,207 discloses a multipath detector in an FM receiver for detecting an amplitude modulated FM signal and outputting a control signal to a cut-off circuit so that the high frequency noise due to multipath transmission can be eliminated. The cut-off circuit comprises capacitors connected to ground via controlled attenuators. The use of elements having a variable resistance such as attenuators, which are coupled to capacitors, has the disadvantage that a sudden increase in the resistance of the element(s) prevents the capacitor(s) from discharging. When a signal peak is present at the capacitor, the signal peak value may remain at the capacitor due to the high resistance of the resistive element and the circuit may consequently “hold” the peak signal. In this way, an undesired “detection” of the signal takes place, leading to distortions in the output signal. Such an undesired detection may occur in particular when the capacitors are coupled to ground via these resistive elements, as is the case in said United States Patent.

U.S. Pat. No. 4,878,252 discloses a multi-path detector and an FM diversity receiver comprising such a receiver. The detector provides a very fast detection of multipath noise. The noise suppression, however, depends on the presence of a diversity arrangement which is relatively expensive.

It is an object of the present invention to overcome these and other problems of the prior art and to provide a filter circuit which is capable of effectively suppressing or even eliminating high frequency noise without causing signal distortion.

It is a further object of the present invention to provide a filter circuit which is simple and inexpensive.

It is an additional object of the present invention to provide an apparatus, such as an FM receiver provided with a high frequency noise filter, and to provide a method of suppressing high frequency noise in an FM-receiver.

Accordingly, the present invention provides a filter circuit for suppressing high frequency noise in an FM-receiver, the circuit comprising a first filter branch and a second filter branch connected in parallel, the first filter branch comprising a high pass filter and a multiplier for multiplying a signal passing through the first filter branch and a control signal indicative of high frequency noise, and the second filter branch comprising a low pass filter.

By providing two filter branches, a high pass filter being arranged in a first branch and a low pass filter being arranged in a separate second branch it is ascertained that the low pass filtering is not affected by any changes in the high pass filtering.

By providing a multiplier instead of an attenuator or other resistive element the undesired signal “detection” and “hold” phenomena mentioned above are avoided.

The multiplier is preferably arranged downstream from the high pass filter. That is, in the signal path the high pass filter comes first, followed by the multiplier. In this way, any distortion of the high frequency signal is avoided.

Preferably, the high pass filter is devoid of a capacitor connected to ground. That is, the high-pass filter preferably has no connection between a signal line and ground which comprises a capacitor. In this way, the above-mentioned undesired “detection” effects are further avoided.

Although various filter configurations are possible, the low pass filter preferably comprises a series resistance and a capacitor connected to ground, and the high pass filter preferably comprises a series capacitor and a resistor connected to ground. This so-called first-order filter arrangement is both simple and effective. Instead of a filter using discrete components, a digital filter having a substantially similar filter behavior could also be utilized.

Advantageously, the filter circuit according to the present invention further comprising an adder for adding a signal from the first filter branch and a signal from the second filter branch.

In order to avoid any signal distortion the filter circuit according to the present invention preferably has a fixed cross-over point (that is, the frequency dividing the high pass and the low pass bands). Advantageously, both the high pass filter and the low pass filter have a cut-off frequency ranging between 0.1 and 2.0 kHz, preferably between 0.2 and 1.1 kHz. In other words, the cross-over point preferably is fixed at a frequency of, for example, 300 Hz or 1.0 kHz. This provides a convenient and effective separation of the high frequency and low frequency signal components. It will of course be understood that other cross-over frequencies, for example 2.0 kHz or 3.0 kHz, are also possible.

The present invention also provides a device, such as an FM-receiver, comprising a noise detector circuit coupled with a filter circuit, wherein the filter circuit is a filter circuit as defined above.

The present invention will further be explained below with reference to exemplary embodiments illustrated in the accompanying drawings, in which:

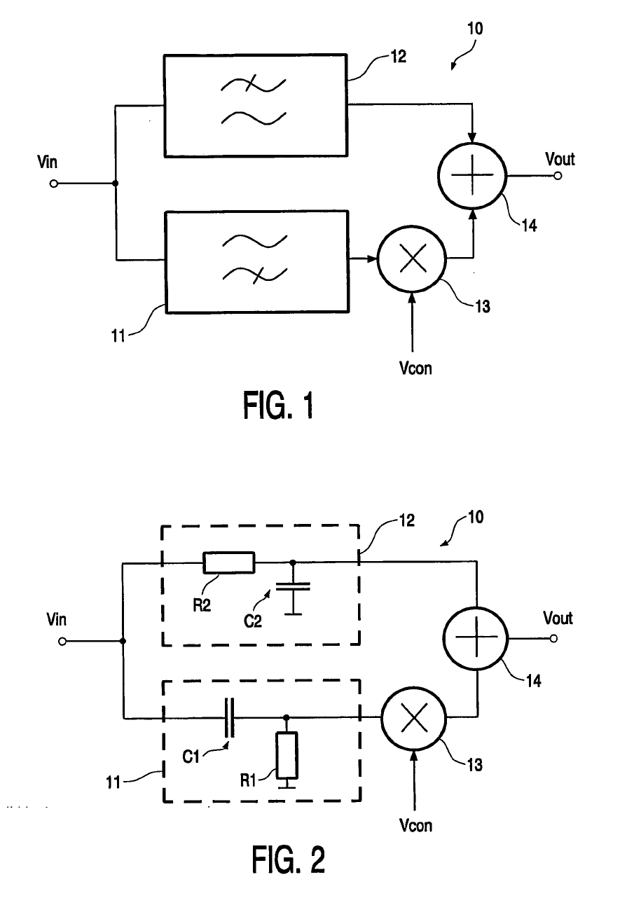

FIG. 1 schematically shows a circuit diagram of a filter circuit according to the present invention.

FIG. 2 schematically shows the circuit diagram of FIG. 1 in more detail.

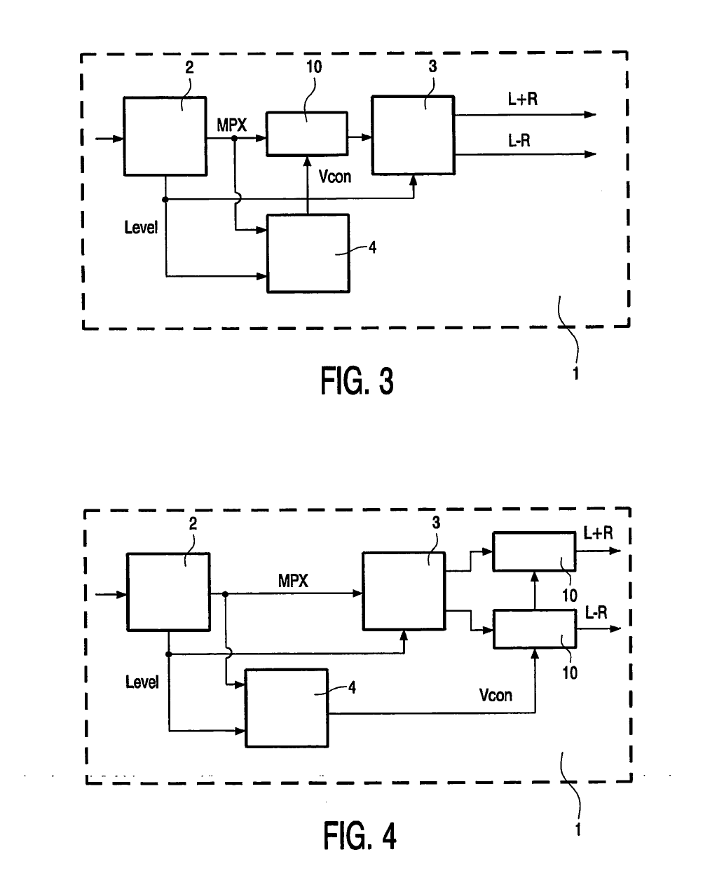

FIG. 3 schematically shows a first embodiment of an FM receiver according to the present invention.

FIG. 4 schematically shows a second embodiment of an FM receiver according to the present invention.

The filter circuit 10 shown merely by way of non-limiting example in FIG. 1 comprises two parallel filter branches, a first filter branch and a second filter branch. The first filter branch comprises a high-pass filter 11 and a multiplier 13, while-the second filter branch comprises a low-pass filter 12. The two branches are joined at an adder 14.

The high-frequency component of an input signal Vᵢₙ passes through the high-pass filter 11 and reaches the multiplier 13, where it is multiplied by a control signal V_{con}. This control signal is originally generated by a noise detector, such as a multipath noise detector, and will later be discussed in more detail. Depending on the detected noise level the control signal V_{con} may have a value ranging between 0 and 1 (it will be understood that these values are exemplary only and that other values may be used without departing from the scope of the present invention).

In the absence of noise the control signal has (in the present example) a value of 1. As a result, the high frequency signal is passed unchanged to the adder 14, where it is added to the low-frequency signal which passed through low-pass filter 12. If noise is present, however, the control signal is smaller than 1 and has a value of for example 0.5, in which case the amplitude of the high-frequency signal is reduced by 50%. It is noted that the amplitude of the low-frequency signal remains unchanged. If significant amounts of high-frequency noise are present, the control signal V_{con} may reach a value of zero, in which case the high-frequency signal is not passed on to the adder 14.

In FIG. 2 a preferred embodiment of the filter circuit according to the present invention is shown in more detail. The high-pass filter is shown to comprise a series capacitor C1 and a resistor R2 connected to ground. It is noted that the high-pass filter 11 of FIG. 2 contains no capacitor connected to ground, as is the case in the Prior Art arrangements discussed above where such a capacitor could give rise to signal distortion due to undesired signal “detection”. Furthermore, the combination of (a) a high-pass filter devoid of a capacitor connected to ground, and (b) a multiplier, avoids any signal distortion due to variations in the control signal V_{con}. The low-pass filter 12 comprises a series resistor R2 and a capacitor C2 connected to ground. As the low-pass filter is followed by the adder 14 and not by the multiplier 13, no detrimental effects are caused by this circuit arrangement.

The multiplier 13 may be a multiplier circuit known per se and may, for example, comprise an integrated circuit multiplier AD532 manufactured by Analog Devices, Inc., of Norwood, Mass., USA, or any other suitable multiplier circuit. Alternatively, pulse-modulated switches could be used as is well known to those skilled in the art. The adder 14, which adds the high-frequency signal and the low-frequency signal to produce the output signal Vₒᵤₜ, may also be a adder circuit known per se and could simple comprise a set of two resistors, or an arrangement of two voltage controlled current sources whose currents are converted into voltages in a single resistor. Such arrangements are also well known in the art.

Instead of the (first-order) filter circuits shown, higher-order filter circuits could be used. It has been found, however, that the circuits shown have suitable characteristics while being extremely simple. Filter circuits having physical components could be replaced by digital filter circuits.

Exemplary component values are: R1=R2−50 kΩ, C1=C2=10 nF. An output resistor of e.g. 5 kΩ may optionally be connected between the output terminal (Vₒᵤₜ) and ground. It is noted that in the variable filter of the present invention it is not the cross-over frequency which is variable but the level of the high-frequency signal.

The exemplary circuit of FIG. 3 is part of an FM receiver 1 which may be employed in, for example, car radios. The circuit comprises an FM demodulator 2, a stereo decoder 3, a noise detector 4 and a filter circuit 10. The FM demodulator 2 and the stereo decoder 3 may be circuits which are known per se. The noise detector 4 may also be a detector known per se but preferably is the detector disclosed in above-mentioned U.S. Pat. No. 4,878,252, the entire disclosure of which is hereby incorporated by reference in this specification.

The demodulator 2, which may also comprise an FM intermediate frequency amplifier, receives the input signal to the circuit of FIG. 3 and outputs an MPX signal (which contains the L+R and L−R signals) and a Level (AM) signal. In the embodiment shown, both the MPX signal and the Level signal are passed on to the stereo decoder 3, although embodiments can be envisaged in which only the MPX signal is passed on to the stereo decoder 3. In the embodiment of FIG. 3, the MPX signal first passes through a filter circuit 10 as discussed above with reference to FIGS. 1 and 2. The MPX and Level signals are also received by the noise detector 4 which in turn outputs a control signal indicative of the noise level, preferably including the multipath noise level. This control signal (V_{con} in FIGS. 1 and 2) causes the suppression of high frequency noise as explained above. The stereo decoder 3 receives the filtered MPX signal and outputs signals L and R, being the Left and Right stereo signals respectively.

The noise detector 4 may further comprise an MPX analysis circuit, a level analysis circuit, a combination circuit for combining an MPX analysis signal and a level analysis signal, and/or a non-linear circuit for adapting the noise detector output signal to the filter circuit 10.

An alternative embodiment is shown in FIG. 4, where the FM receiver circuit is similar to the circuit of FIG. 3 but where the filter circuit between the demodulator 2 and the stereo decoder 3 has been omitted; Instead, filter circuits 10 according to the present invention are arranged at the outputs of the stereo decoder 3 so as to filter the L and R signals. In a further alternative embodiment (not shown), the circuits of FIGS. 3 and 4 are combined to produce a circuit having three filter circuits 10 according to the present invention.

As stated above, the multipath detector disclosed in U.S. Pat. No. 4,878,252 is particularly suitable for use with the filter of the present invention. The multi-path detector of U.S. Pat. No. 4,878,252 comprises a frequency noise peak detector and/or an AM detector. In the preferred embodiment the frequency noise peak detector is connected to the FM demodulator while the AM detector is connected to the intermediate frequency section. The frequency noise peak detector has an output to which a noise peak signal is applied. This signal is produced when this detector detects multi-path distortion in the form of noise peaks in the received angle-modulated input signal. The AM-detector has an output to which an AM-indication signal is applied when the AM-detector detects multi-path distortion in the form of amplitude modulations in the received angle-modulated input signal. The frequency noise peak detector successively comprises a series arrangement composed of a band-pass filter, a high-pass filter, a rectifier circuit, a summing circuit and a comparator circuit for supplying a bivalent noise peak indication signal to the indication output. The comparator circuit comprises two inputs, one of which is connected to the summing output of the summing circuit, the other being coupled via a summing circuit to a terminal to which a direct voltage source can be connected for supplying a threshold bias voltage. The bandpass filter, connected to the FM demodulator, has a passband exceeding the bandwidth of the received angle-modulated signal and ranging from the example 15 Hz to approximately 200 kHz. The portion of this signal exceeding, for example, 50 to 60 kHz is allowed to pass through the high-pass filter and is subsequently rectified by the rectifier circuit. At the moments when the angle-modulated signal is subjected to multi-path distortion the rectified signal supplied to the summing circuit will show noise peaks which are commonly known. At the moments when the level of the noise peaks on one input exceeds the level of the bias voltage on the other input, the comparator circuit supplies the signal indicating the noise peak to the output.

The AM-detector comprises an amplitude demodulator, connected to the intermediate-frequency section in the disclosed embodiment, a band-pass filter connected in series to the demodulator and a comparator circuit. The comparator circuit has two inputs. One input is coupled to the band-pass filter via a summing circuit, and via a summing circuit the other input is coupled to a terminal to which a direct voltage source which is not shown, can be connected for supplying a threshold bias voltage. The pass-band of the bandpass filter covers an area wherein the frequency components are present of the amplitude modulations caused by multi-path distortion. The pass-band, for example, ranges from 5 Hz to 50 kHz. At moments when the value of the amplitude modulation exceeds the value of the bias voltage on the second input, the comparator circuit will supply the AM-indication signal to the output.

When using the frequency noise peak detector and the AM detector, the multi-path detector comprises a weighting circuit connected to the two detectors, for supplying the control signal to the control input solely in cases when the two indication signals are simultaneous. The weighting circuit is then designed as an AND-gate circuit connected to the indication outputs.

Although the multipath detector disclosed in U.S. Pat. No. 4,878,252 is particularly suitable for use with the filter of the present invention, it will be understood that the present invention is not so limited and that other suitable multipath detectors, or detectors for detecting other types of noise and/or signal distortion, may be substituted in its place.

The present invention is based upon the insight that in a variable high-frequency noise filter a sudden change in a resistive element following a capacitor may lead to signal distortion. The present invention is further based upon the additional insight that capacitors coupled to ground should be avoided in a variable high-frequency noise filter. In addition, the present invention recognizes that the combination of (a) a multipath detector having a very quick response and (b) a suitable filter allows multipath noise to be effectively suppressed.

It is noted that any terms used in this document should not be construed so as limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A filter circuit for suppressing high frequency noise in an FM-receiver, the circuit comprising a first filter branch and a second filter branch connected in parallel, the first filter branch comprising a high pass filter and a multiplier for multiplying a signal passing through the first filter branch and a control signal indicative of high frequency noise, and the second filter branch comprising a low pass filter.

2. The filter circuit according to claim 1, wherein the multiplier is arranged downstream from the high pass filter.

3. The filter circuit according to claim 1, wherein the high pass filter is devoid of a capacitor connected to ground.

4. The filter circuit according to claim 1, wherein the low pass filter comprises a series resistance and a capacitor connected to ground, and wherein the high pass filter comprises a series capacitor and a resistor connected to ground.

5. The filter circuit according to claim 1, further comprising an adder for adding a signal from the first filter branch and a signal from the second filter branch.

6. The filter circuit according to claim 1, wherein both the high pass filter and the low pass filter have a cut-off frequency ranging between 0.1 and 2.0 kHz, preferably between 0.2 and 1.1 kHz.

7. An apparatus, comprising a noise detector circuit coupled to a filter circuit according to claim 1.

8. The apparatus according to claim 7, which is an FM receiver further comprising a stereo decoder, wherein the filter circuit is located immediately after the stereo decoder.

9. The apparatus according to claim 7, which is an FM receiver further comprising a stereo decoder, wherein the filter circuit is located immediately before the stereo decoder.

10. A method of suppressing high frequency noise in an FM-receiver, the method comprising:
high pass filtering a first signal component,
multiplying the first signal component by a control signal indicative of the high frequency noise,
low pass filtering a second signal component, and
adding the filtered first signal component and the filtered second signal component.
